(19) United States
(12) Patent Application Publication
(10) Pub. No.: US 2025/0211628 A1
(43) Pub. Date: Jun. 26, 2025

(54) POLICY CONTROL AND CHARGING FOR DATA CHANNELS IN INTERNET PROTOCOL MULTIMEDIA SUBSYSTEM NETWORKS

(71) Applicant: QUALCOMM Incorporated, San Diego, CA (US)

(72) Inventors: Kefeng ZHANG, Beijing (CN); Haris ZISIMOPOULOS, London (GB); Carlos Marcelo Dias PAZOS, Carlsbad, CA (US)

(21) Appl. No.: 18/848,843

(22) PCT Filed: May 5, 2022
(86) PCT No.: PCT/CN2022/090906

§ 371 Date: Sep. 19, 2024

(51) Int. Cl. H04L 65/80; H04L 12/14; H04L 65/1104; H04W 28/10

(52) U.S. Cl. CPC H04L 65/80; H04L 12/1407; H04L 65/1104; H04W 28/10

(57) ABSTRACT

Methods, systems, and devices for wireless communications are described. A user equipment (UE) may transmit a session description protocol (SDP) offer to the network, and may include in the SDP offer an indication of an application identifier (ID) and quality of service (QoS) hint information (e.g., a threshold QoS for the application). The network may utilize the application ID to determine charging (e.g., billing) information for the user. Additionally, or alternatively, the network may consider the threshold QoS in determining (e.g., authorizing) a QoS resource on the data channel for the UE to initiate communication on the data channel.

### CROSS REFERENCE

The present application is a 371 national stage filing of International PCT Application No. PCT/CN2022/090906 by ZHANG et al. entitled “POLICY CONTROL AND CHARTING FOR DATA CHANNELS IN INTERNET PROTOCOL MULTIMEDIA SUBSYSTEM NETWORKS,” filed May 5, 2022, which is assigned to the assignee hereof, and which is expressly incorporated by reference in its entirety herein.

### FIELD OF TECHNOLOGY

The following relates to wireless communications, including policy control and charging for data channels in internet protocol multimedia subsystem networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support policy control and charging for data channels in internet protocol multimedia subsystem networks. For example, techniques described herein may support a user equipment (UE) transmitting a session description protocol (SDP) offer to the network. The SDP offer (e.g., SDP invitation) may include an indication of an application identifier (ID) and quality of service (QoS) hint information (e.g., a threshold QoS for the application). The network may utilize the application ID to determine charging (e.g., billing) information for the user. Additionally, or alternatively, the network may consider the threshold QoS in determining (e.g., authorizing) a QoS resource on the data channel for the UE to initiate communication on the data channel.

A method for wireless communications at a user equipment (UE) is described. The method may include transmitting an SDP offer for an application associated with a data channel, the SDP offer including an application identifier associated with the application and one or more indications of a threshold quality of service associated with the application, receiving an SDP response for the application associated with the data channel based on transmitting the SDP offer, the SDP offer authorizing a quality of service resource that satisfies the threshold quality of service, and transmitting a response confirmation based on receiving the SDP response.

An apparatus for wireless communications at a UE is described. The apparatus may include a processor, memory coupled with the processor, and instructions stored in the memory. The instructions may be executable by the processor to cause the apparatus to transmit an SDP offer for an application associated with a data channel, the SDP offer including an application identifier associated with the application and one or more indications of a threshold quality of service associated with the application, receive an SDP response for the application associated with the data channel based on transmitting the SDP offer, the SDP offer authorizing a quality of service resource that satisfies the threshold quality of service, and transmit a response confirmation based on receiving the SDP response.

Another apparatus for wireless communications at a UE is described. The apparatus may include means for transmitting an SDP offer for an application associated with a data channel, the SDP offer including an application identifier associated with the application and one or more indications of a threshold quality of service associated with the application, means for receiving an SDP response for the application associated with the data channel based on transmitting the SDP offer, the SDP offer authorizing a quality of service resource that satisfies the threshold quality of service, and means for transmitting a response confirmation based on receiving the SDP response.

A non-transitory computer-readable medium storing code for wireless communications at a UE is described. The code may include instructions executable by a processor to transmit an SDP offer for an application associated with a data channel, the SDP offer including an application identifier associated with the application and one or more indications of a threshold quality of service associated with the application, receive an SDP response for the application associated with the data channel based on transmitting the SDP offer, the SDP offer authorizing a quality of service resource that satisfies the threshold quality of service, and transmit a response confirmation based on receiving the SDP response.

Some examples of the method, apparatuses, and non-transitory computer-readable medium described herein may further include operations, features, means, or instructions for initiating communication by the application on the data channel in an internet protocol multimedia subsystem session based on outputting the SDP response and according to the threshold quality of service.

In some examples of the method, apparatuses, and non-transitory computer-readable medium described herein, the application identifier includes a label indicating a name of the data channel.

In some examples of the method, apparatuses, and non-transitory computer-readable medium described herein, the application identifier includes a media level attribute of a data channel map associated with the data channel.

In some examples of the method, apparatuses, and non-transitory computer-readable medium described herein, the application identifier includes a media level attribute of a data channel sub-protocol attribute associated with the data channel.

In some examples of the method, apparatuses, and non-transitory computer-readable medium described herein, and the method, apparatuses, and non-transitory computer-readable medium may include further operations, features, means, or instructions for a public land mobile network identifier, a data channel application provider, a data channel application number allocated by a network provider, a data channel application name, or any combination thereof.

In some examples of the method, apparatuses, and non-transitory computer-readable medium described herein, the threshold quality of service may include operations, features, means, or instructions for a threshold packet loss for the application, a threshold latency for the application, or both.

Some examples of the method, apparatuses, and non-transitory computer-readable medium described herein may further include operations, features, means, or instructions for obtaining an indication of the application identifier in connection with installing the application at the UE and including the indication of the application identifier in the SDP offer.

Some examples of the method, apparatuses, and non-transitory computer-readable medium described herein may further include operations, features, means, or instructions for receiving a data channel application package associated with the application, the data channel application package including the application identifier and including the indication of the application identifier in the SDP offer based on the data channel application package.

A method for wireless communications at a network device is described. The method may include obtaining an SDP offer from a first UE for an application associated with a data channel, the SDP offer including an application identifier associated with the application and one or more indications of a threshold quality of service associated with the application, outputting an SDP response for the application associated with the data channel based on receiving the SDP offer, the SDP offer authorizing a quality of service resource that satisfies the threshold quality of service, and obtaining a response confirmation based on receiving the SDP response.

An apparatus for wireless communications at a network device is described. The apparatus may include a processor, memory coupled with the processor, and instructions stored in the memory. The instructions may be executable by the processor to cause the apparatus to obtain an SDP offer from a first UE for an application associated with a data channel, the SDP offer including an application identifier associated with the application and one or more indications of a threshold quality of service associated with the application, output an SDP response for the application associated with the data channel based on receiving the SDP offer, the SDP offer authorizing a quality of service resource that satisfies the threshold quality of service, and obtain a response confirmation based on receiving the SDP response.

Another apparatus for wireless communications at a network device is described. The apparatus may include means for obtaining an SDP offer from a first UE for an application associated with a data channel, the SDP offer including an application identifier associated with the application and one or more indications of a threshold quality of service associated with the application, means for outputting an SDP response for the application associated with the data channel based on receiving the SDP offer, the SDP offer authorizing a quality of service resource that satisfies the threshold quality of service, and means for obtaining a response confirmation based on receiving the SDP response.

A non-transitory computer-readable medium storing code for wireless communications at a network device is described. The code may include instructions executable by a processor to obtain an SDP offer from a first UE for an application associated with a data channel, the SDP offer including an application identifier associated with the application and one or more indications of a threshold quality of service associated with the application, output an SDP response for the application associated with the data channel based on receiving the SDP offer, the SDP offer authorizing a quality of service resource that satisfies the threshold quality of service, and obtain a response confirmation based on receiving the SDP response.

Some examples of the method, apparatuses, and non-transitory computer-readable medium described herein may further include operations, features, means, or instructions for authorizing a quality of service resource that satisfies the threshold quality of service, where outputting the SDP response may be based on the authorizing.

Some examples of the method, apparatuses, and non-transitory computer-readable medium described herein may further include operations, features, means, or instructions for forwarding the SDP offer to a second UE and obtaining the SDP response from the second UE.

In some examples of the method, apparatuses, and non-transitory computer-readable medium described herein, outputting the SDP response may include operations, features, means, or instructions for forwarding the SDP response obtained from the second UE to the first UE.

Some examples of the method, apparatuses, and non-transitory computer-readable medium described herein may further include operations, features, means, or instructions for initiating communication by the application on the data channel in an internet protocol multimedia subsystem session based on outputting the SDP response and according to the threshold quality of service.

Some examples of the method, apparatuses, and non-transitory computer-readable medium described herein may further include operations, features, means, or instructions for generating charging information associated with the application for the internet protocol multimedia subsystem session based on the application identifier.

Some examples of the method, apparatuses, and non-transitory computer-readable medium described herein may further include operations, features, means, or instructions for providing the charging information to a service provider associated with the first UE.

In some examples of the method, apparatuses, and non-transitory computer-readable medium described herein, the application identifier includes a label indicating a name of the data channel.

In some examples of the method, apparatuses, and non-transitory computer-readable medium described herein, the application identifier includes a media level attribute of a data channel map associated with the data channel.

In some examples of the method, apparatuses, and non-transitory computer-readable medium described herein, the application identifier includes a media level attribute of a data channel sub-protocol attribute associated with the data channel.

In some examples of the method, apparatuses, and non-transitory computer-readable medium described herein, and the method, apparatuses, and non-transitory computer-readable medium may include further operations, features, means, or instructions for a public land mobile network identifier, a data channel application number allocated by a network provider, a data channel application name, or any combination thereof.

Some examples of the method, apparatuses, and non-transitory computer-readable medium described herein may further include operations, features, means, or instructions for associating the application identifier with a data channel application package corresponding to the application, where receiving the SDP offer including the application identifier may be based on associating the application identifier with the data channel application package.

In some examples of the method, apparatuses, and non-transitory computer-readable medium described herein, the threshold quality of service may include operations, features, means, or instructions for a threshold packet loss for the application, a threshold latency for the application, or both.

### BRIEF DESCRIPTION OF THE DRAWINGS

FIG. 1 illustrates an example of a wireless communications system that supports policy control and charging for data channels in internet protocol multimedia subsystem networks in accordance with one or more aspects of the present disclosure.

FIG. 2 illustrates an example of a wireless communications system that supports policy control and charging for data channels in internet protocol multimedia subsystem networks in accordance with one or more aspects of the present disclosure.

FIG. 3 illustrates an example of a process flow that supports policy control and charging for data channels in internet protocol multimedia subsystem networks in accordance with one or more aspects of the present disclosure.

FIGS. 4 and 5 show block diagrams of devices that support policy control and charging for data channels in internet protocol multimedia subsystem networks in accordance with one or more aspects of the present disclosure.

FIG. 6 shows a block diagram of a communications manager that supports policy control and charging for data channels in internet protocol multimedia subsystem networks in accordance with one or more aspects of the present disclosure.

FIG. 7 shows a diagram of a system including a device that supports policy control and charging for data channels in internet protocol multimedia subsystem networks in accordance with one or more aspects of the present disclosure.

FIGS. 8 and 9 show block diagrams of devices that support policy control and charging for data channels in internet protocol multimedia subsystem networks in accordance with one or more aspects of the present disclosure.

FIG. 10 shows a block diagram of a communications manager that supports policy control and charging for data channels in internet protocol multimedia subsystem networks in accordance with one or more aspects of the present disclosure.

FIG. 11 shows a diagram of a system including a device that supports policy control and charging for data channels in internet protocol multimedia subsystem networks in accordance with one or more aspects of the present disclosure.

FIGS. 12 through 17 show flowcharts illustrating methods that support policy control and charging for data channels in internet protocol multimedia subsystem networks in accordance with one or more aspects of the present disclosure.

### DETAILED DESCRIPTION

In some wireless communications systems, a user equipment (UE) may use one or more applications on a data channel. For example, the UE may use one or more applications for wireless communications with another UE (e.g., via a network). However, in some examples, techniques for charging users for data channel usage may not be granular to the point of being application-specific. For example, some charging for internet protocol management sessions (IMS) sessions (e.g., initiated via session description protocol (SDP) signaling) may simply be global for data channel usage regardless of individual application usage. However, such global charging procedures may not take into account the complications, quality of service requirements, level of complexity, priority, or other costs related to individual applications. Additionally, some applications may have a higher tolerance to variable quality of service than others. Thus, some data channels may or may not support some applications (e.g., if a data channel does cannot support a quality of service requirement for a particular application).

Techniques described herein may support specific quality of service levels for different applications, and may further support granular charging mechanisms that are application specific. A UE may transmit an SDP offer to the network, and may include in the SDP offer an indication of an application identifier (ID) and quality of service (QoS) hint information (e.g., a threshold QoS for the application). The network may utilize the application ID to determine charging (e.g., billing) information for the user. Additionally, or alternatively, the network may consider the threshold QoS in determining (e.g., authorizing) a QoS resource on the data channel for the UE to initiate communication on the data channel.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to policy control and charging for data channels in internet protocol multimedia subsystem networks.

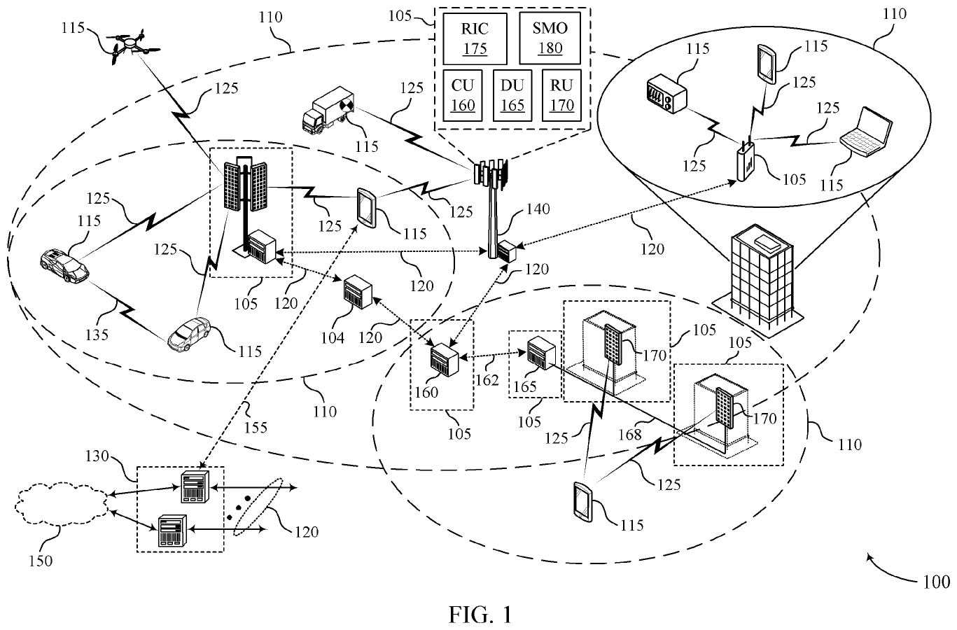

FIG. 1 illustrates an example of a wireless communications system 100 that supports policy control and charging for data channels in internet protocol multimedia subsystem networks in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a LUE 115 (e.g., any LUE described herein), a network controller, an apparatus, a device, a computing system, one or more components, or another suitable processing entity configured to perform any of the techniques described herein. For example, a node may be a LUE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support policy control and charging for data channels in internet protocol multimedia subsystem networks as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

A UE 115 may transmit an SDP offer to the network, and may include in the SDP offer an indication of an application ID and QoS hint information (e.g., a threshold QoS for the application). The network may utilize the application ID to determine charging (e.g., billing) information for the user. Additionally, or alternatively, the network may consider the threshold QoS in determining (e.g., authorizing) a QoS resource on the data channel for the UE to initiate communication on the data channel.

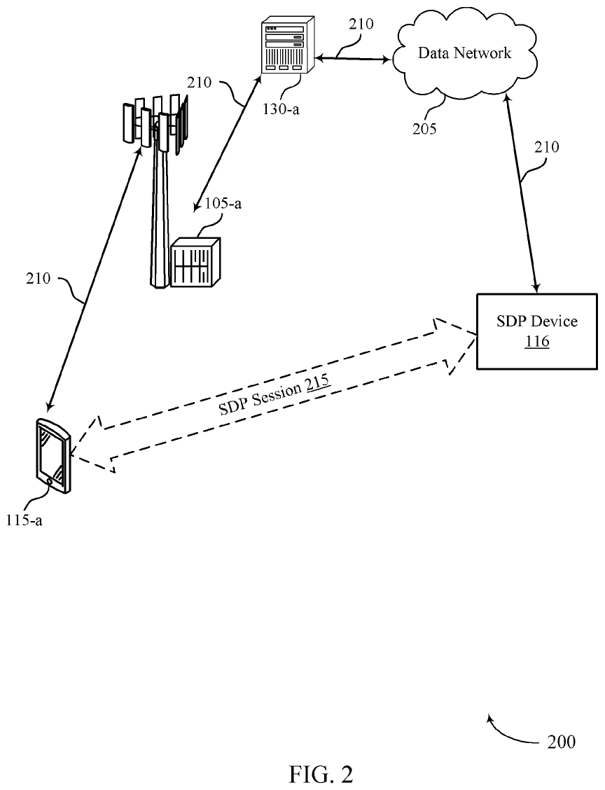

FIG. 2 illustrates an example of a wireless communications system 200 that supports policy control and charging for data channels in internet protocol multimedia subsystem networks in accordance with one or more aspects of the present disclosure. wireless communications system 200 may include a network entity 105-a, and one or more UEs 115 (e.g., a UE 115-a), a core network 130-a, a data network 205, which may be examples of corresponding devices described with reference to FIG. 1. The wireless communications system 200 may also include an SDP device 116, which may be an example of another UE 115, a server, or other device capable of communicating with the UE 115-a via an SDP session 215.

The wireless communications system 200 may support communications between the UE 115-a and another wireless device, such as the SDP device 116. the data network 205 via the network entity 105-a and the core network 130-a. For example, the UE 115-a may connect to the network entity 105-a via a bidirectional communication link 210, the network entity 105-a may communicate with the core network 130-a, and the core network 130-a may provide one or more gateways to the data network 205. The data network 205 may include one or more packet-switched data networks (PDNs), such as an internal or restricted data network, the internet or another public data network, or combinations thereof.

The core network 130 may, in some examples, include one or more IMS entities, and may support an IMS session, such as to implement the SDP session 215, that allow the UE 115-a to communicate with other devices, such as the SDP device 116, via data network 205. The SDP session 215 may include negotiation procedures, such as transmission of an SDP offer (e.g., from the UE 115-a to the SDP device 116) or receiving an SDP response (e.g., from the SDP device 116 to the UE 115-a), which may be facilitated by the IMS entities that support the IMS session.

In one example, the SDP device 116 may be a second UE which connects to the data network 205 via a different network entity and core network. Thus, the UE 115-a may communicate with the SDP device 116 by negotiating the SDP session 215 with the SDP device 116 via the core network 130-a (e.g., via connection with the network entity 105-a). In this example, the UE 115-a may communicate with the SDP device 116 via the SDP session 215, which may be routed through the network entity 105-a serving the UE 115-a, the core network 130-a, the data network 205, the core network of the SDP device 116, and the network entity serving the SDP device 116.

In another example, the SDP device 116 and the data network 205 may include the internet. In this example, the SDP session 215 may be routed through the network entity 105-a serving the UE 115-a, the core network 130-a, and the data network 205 directly to the SDP device 116.

The wireless communications system 200 may support multimedia IMS sessions, such as the SDP session 215, which may be used to implement video calls between the UE 115-a and the SDP device 116. IMS data channels and associated sessions may support a variety of media types between two end points (e.g., the UE 115-a and the SDP device 116). The media delivered on the data channel may be standardized, or customized, for specific data channel applications. Multiple data channels may be established simultaneously for a data channel multimedia telephony service for IMS (MTSI), which may support traffic delivery of different data channel applications. However, the IMS network may not have access to information regarding QoS requirements for different media types delivered via the data channels. Without access to such information, the network may not be able to accurately or efficiently allocate correlated QoS resources on the data channels (e.g., correlated bearer resources in an IP connectivity access network (IP-CAN)). Further, without techniques for identifying specific application usage on data channels, the network may not be able to identify and provide users or providers with granular, application-specific, charging (e.g., billing) information.

When an application of the UE 115-a initiates the SDP session 215 to communicate with an application of the SDP device 116, one or more data channel SDP media descriptions may be included in an SDP offer (e.g., alongside other SDP media descriptions, such as speech, video, etc.). Multiple data channels may be mapped to a single data channel SDP media description, each with a corresponding SDP attribute (e.g., a=dcmap”) and stream ID.

During SDP negotiation procedures, IMS network entities (e.g., proxy call session control function (P-CSCF), serving call session control function (S-CSCF), etc.) may trigger reporting of charging data record (CDR) information of the SDP session to a charging system. Reported CDR may carry a list of SDP media components included in an SDP offer and/or SDP response. A consumer of data channel applications, the IMS network provider, and the data channel applications may have access to use records of each data channel application (e.g., data channel application ID, application start time, application closure time, etc.). However, if such information is not included in the SDP media description of the data channel, then such information cannot be used for more granular billing procedures and improved quality of service. Techniques to provide such information are described herein.

The UE 115-a may be allocated the data channel (e.g., via an indication of a data channel stream ID). The data channel stream ID may be allocated for other data channel applications after a previous data channel is released. IMS network entities may not have access to a mapping relationship between data channel applications and data access stream IDs, and may not have access to usage information of data channel applications.

As described herein, to efficiently and effectively collect charging information for data channel services, and to support data channel application usage statistics, the UE 115-a may utilize SDP media descriptions of a data channel to identify a serving application of each data channel with data channel application IDs. UE 115 (e.g., the UE 115-a) may transmit an SDP offer (e.g., message 215-a) to the network, and may include in the SDP offer an indication of an application ID, QoS hint information (e.g., a threshold QoS for the application), or both.

The QoS hint information may be included in an SDP attribute (e.g., a=3gpp-qos-hint). The QoS hint information may be referred to as a threshold QoS for a particular application. The threshold QoS may indicate threshold packet loss or latency that the data channel media of a particular data channel application can support. In such examples, a data channel MTSI supporting UE (e.g., the UE 115-a) may include the QoS hint information in the SDP offer message. In such examples, the network (e.g., at a policy control level) may take the QoS hint information into account for the affected media (e.g., for the application indicated in the SDP offer). In some examples, if QoS hint information is not provided in the SDP, then the network may default to a fallback QoS level, or may derive a best-effort transport level QoS information according to one or more conditions or parameters (e.g., based on UE subscription information, network policy, or a combination thereof, among other examples).

For example, The UE 115-a may request (e.g., in the QoS hint information), a 2% loss, end-to-end, but the local link at the UE 115-a may support a threshold of 1% loss. IN such examples, the UE 115-a may include, in the SDP request, QoS hint information indication loss=2. The SDP device 116 may be able to accept a threshold of 2% loss, end-to-end, and a local link at the SDP device 116 may support a threshold of 1% loss. In such examples, the SDP device 116 may indicate, in an SDP response, a QoS hint of loss=2. This may result in a threshold packet loss of 2% (e.g., 1%+1%=2%). Similarly, if the UE 115-a requests a threshold of 0.2% loss with a local link that supports a threshold of 0.1%, while the SDP device 116 may accept a threshold of 0.2% loss with a local link that supports a threshold of 0.1% loss, then the resulting threshold loss may be 0.2%. If the UE 115-a requests a threshold of 0.02% loss with a local link that supports a threshold of 0.01%, while the SDP device 116 may accept a threshold of 0.02% loss with a local link that supports a threshold of 0.01% loss, then the resulting threshold loss may be 0.02%.

In some examples, the UE 115-a and the network may negotiate more than one data channels, with different QoS requirements in a same media description of an SDP offer. In such examples, threshold QoS values (e.g., requirements) of all indicated data channel streams may be aggregated, and derived into a single line of an SDP attribute (e.g., a=3gpp-qos-hint attribute line applies jointly to aggregate of all packets, if more than one media stream is part of the same media description). The QoS hint information included in such an attribute may apply equally to all packets in the requested one or more data channels.

In some examples, the UE 115-a that is a data channel MTSI UE may request to establish a data channel with a particular threshold QoS. In such examples, a separate media description with QoS hint information (e.g., a=3gpp-qos-hint attribute) may be included in the SDP offer. An established data channel may be associated with different configurations (e.g., user datagram protocol (UDP) configurations, datagram transport layer security (DTLS) configurations, or stream control transmission protocol (SCTP) configurations, among other examples). Different sources, destinations, or both, UDP ports may be used to the transport layer for the indicated data channel. In some examples, Different IP addresses (e.g., IP version 6 (IPv6)) addresses) may be used if the UE 115-a is allocated with an IP prefix. In some examples, IP tuple information of a data channel transport layer may be provided by one or more IMS entities (e.g., a P-CSCF to a policy control function (PCF) in service data flow filters. Data channels may be mapped to various media types.

In some examples, the UE 115-a may include, in an SDP offer, an indication of an application ID. In some examples, the application ID may be included in a media description of the SDP. In such examples, the PCF may verify the QoS hint information provided by the UE, and may determine an appropriate QoS configuration for the application on the data channel based on the QoS hint information, the application ID, operator policy, or any combination thereof.

An application ID may be defined or provided by a third party entity (e.g., application function (AF) or high level operating systems (HLOS)). In some examples, the UE 115-a may obtain the application ID upon downloading or installing the application. The Application ID may be allocated by the IMS network provider for each data channel application (e.g., that is uploaded to a data channel application repository). The allocated data channel application ID may be configured in the data channel application package, or may be signaled to the UE when the data channel application is downloaded or installed to the UE 115-a in a bootstrap data channel. When the UE 115-a initiates the data channel for the application (e.g., initiates communications on the data channel using the application), the data channel application may be included in an SDP media description of the SDP offer.

The network provider may define each data channel application ID, and each data channel application ID may include one or more elements or parameter values. For example, the application ID may include a public land mobile network (PLMN) ID (e.g., including an mobile network code (MNC) and an mobile country code (MCC)). The application ID may include a data channel application provider (e.g., a user or a network provider). The application ID may include a data channel application number, which may be allocated by the network provider. The application ID may include an application name, which may include human readable information).

The UE 115-a may include an indication of the application ID in the SDP offer (e.g., the message 215-a). The indication of the application ID may include a label attribute for the data channel application ID. For example, the label parameter may indicate a name of the data channel, and may represent a label that is used to distinguish a real-time communication (RTC) data channel object from other RTC data channel objects. For instance, the UE 115-a may include, in the SDP offer, an indication of application #1 (e.g., a=dcmap:38754max-time=150;label=“DC Application #1), an indication of application #2 (e.g., a=dcmap:7216max-retr=5;label=“DC Application #2), or both, among other examples. Such a label may be an existing label (e.g., for differentiating channel objects), that can be reused or repurposed for indication of application IDs. In some examples, the UE 115-a may indicate the application ID via an attribute specific to the data channel application ID in a media level attribute of a data channel map (DCMAP). In such examples, the UE 115-a may include an indication of an application ID for an application #1 (e.g., a-dcmap:38754max-time=150;dcapp-id=“DC Application #1”) in the SDP offer. In some examples, the UE 115-a may indicate the application ID in an attribute specific to the application ID in a media level attribute of a data channel sub-protocol attribute (DCSA). In such examples, the UE 115-a may include an indication of an application #1 (e.g., a=dcmap:38754max-time=150; a=dcsa:38754;dcapp-idd=“DC Application #1).

The network may utilize the application ID to determine charging (e.g., billing) information for the user.

For example, one or more network entities or IMS entities (e.g., a P-CSCF, an S-CSCF, a multimedia resource function (MIRF), a data channel server (DChS), or an IMS-application server (AS), among other examples) may trigger a CDR report to a charging system. The network entities (e.g., the network entity 105-a) may indicate the application ID by including an SDP media description including the data channel application ID (e.g., in the CDR report). IN some examples, DChS may report the CDR to a charging system. For example, the CDR information may be triggered by an event of a bootstrap data channel establishment, update and release, downloading of a data channel application, a UE application triggered data channel establishment to the DChS, etc. Any such triggers may result in a CDR including the indication of the application ID. The charging system may then converge collected CDRs from IMS entities and 5G core (5GC) network functions (NFs). The IMS entities may derive the charging information for various data channel services, according to the MNO policy, or at different levels of granularity (e.g., per IMS session level granularity, per SDP media description level granularity, or per data channel application level granularity, among other examples). Charging information may then be conveyed, by the charging system, to the user for billing purposes.

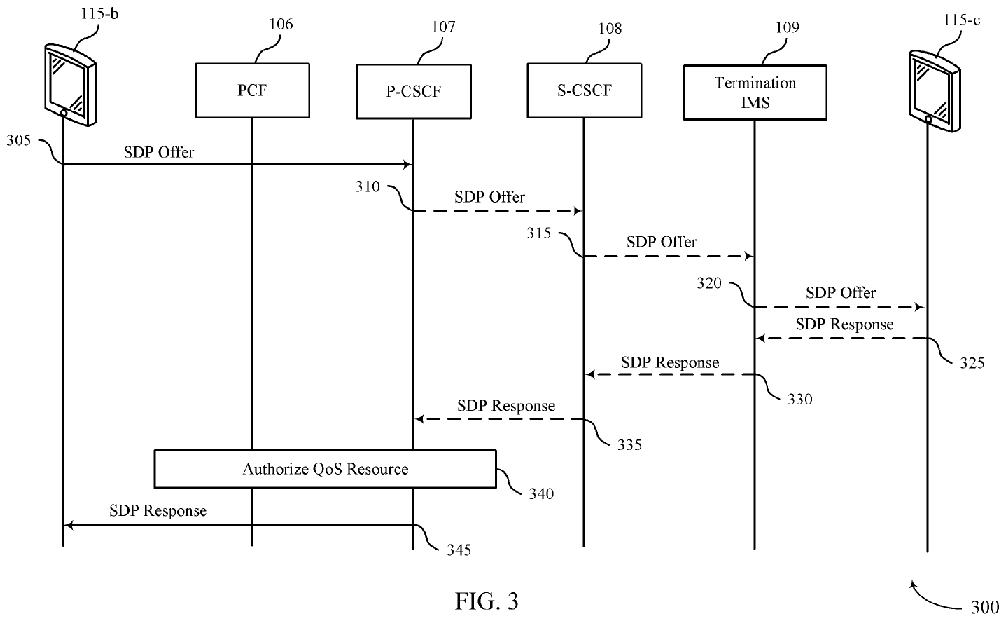

Additionally, or alternatively, the network may consider the threshold QoS in determining (e.g., authorizing) a QoS. For example, the network may allocate channel resources in accordance with the QoS indicated in the SDP offer, as described in greater detail with reference to FIG. 3.

FIG. 3 illustrates an example of a process flow 300 that supports policy control and charging for data channels in internet protocol multimedia subsystem networks in accordance with one or more aspects of the present disclosure. Process flow 300 may include one or more UEs 115 (e.g., a UE 115-b and a UE 115-c), and one or more network entities 105, and one or more IMS entities (e.g., PCF 106, P-CSCF 107, S CSCF 108, and termination IMS 109). In some examples, IMS entities may be examples of network entities 105. The UEs 115 and network entities 105 may be examples of corresponding devices described with reference to FIGS. 1-2. UE 115-c may be an example of the SDP device 116 of FIG. 2. PCF 106 may assist operators create and deploy policies. The PCF 106 may use policy subscription information stored in a user data repository (UDR) to provide policy rules to network functions (session management function (SMF) or access mobility management function (AMF). P-CSCF106 may function as a proxy server for UEs, and session initiation protocol (SIP) signaling traffic may pass through the P-CSCF 107. S-CSCF 107 may act as a primary node in an IMS, and may be responsible for session control. Subscribers may be allocated an S-CSCF for a duration of an IMS registration to facilitate routing of SIP messages as part of service establishment procedures.

At 305, the UE 115-b may transmit an SDP offer for an application associated with a data channel. The SDP offer may include an application ID associated with the application, and one or more indications of a threshold QoS (e.g., QoS hint information) associated with the application. The application ID may be a label indicating a name of the data channel or the application. The application ID may be a media level attribute of a data channel map for the data channel. The Application ID may be a media level attribute of a data channel sub-protocol attribute for the data channel. In some examples, the application ID may include one or more parameter values, such as a PLMN ID, a data channel application provider, a data channel application number allocated by a network provider, a data channel application name, or any combination thereof. The threshold QoS may indicate a threshold packet loss for the application or for the data channel, or a threshold latency for the application or for the data channel, or any combination thereof.

The UE 115-b may obtain the indication of the application ID in connection with installing or downloading the application at the UE 115-b, and may then include the obtained application ID in the SDP offer. In some examples, the UE 115-a may receive a data channel application package for the application, and the data channel application package may include the application ID (e.g., which the UE 115-b may include in the SDP offer). For instance, the data channel application downloaded at the UE 115-b may trigger the establishment of the data channel via an SIP invite request (e.g., an SDP offer) containing SDP media descriptions for one or more data channels. Each data channel attribute may be identified with a data channel application ID in the SDP. IF the data channel application has special QoS requirements (e.g., a threshold QoS), then the UE 115-a may include the QoS hint information (e.g., a line of a=3gpp-qos-hint) in the SDP media description.

One or more network entities 105 may obtain the SDP offer from the UE 115-b, and may output an SDP response for the application and data channel indicated in the SDP offer. One or more network entities may obtain a response confirmation from the UE 115-b based on having output the SDP response. For example, at 310, the P-CSCF 107 may forward the SDP offer to the S-CSCF 108. At 315, the S-CSCF 108 may forward the SDP offer to the termination IMS 109. In some examples, at 320, the termination IMS 109 may forward the SDP offer to another wireless device (e.g., the UE 115-c). The UE 115-c may respond to the SDP offer by generating and transmitting an SDP response. The SDP response may include an accepted media stream description. In some examples, the QoS hint information may be accepted in the SDP. The CDR may be generated by the by the related terminating and originating IMS entities (e.g., the termination IMS 109, S-CSCF 108, the P-CSCF 107, the PCF 106, an IMS-AS, a DChS, an MRFC, or the like), and reported to the charging systems. The CDR may include the DC application ID in the SDP media description.

At 325, the UE 115-c may send an SDP response to the termination IMS 109. The Termination IMS 109 may forward the SDP response to the S-CSCF at 330. At 335, the S-CSCF 108 may forward the SDP response to the P-CSCF. At 340, the P-CSCF 107 may instruct the PCF 106 to authorize a QoS resource for the Data channel according to the SDP media description. The PCF 106 may derive the QoS parameters based on the QoS hint information in the media stream description of the SDP request, the SDP response, or both. The PCF 106 may generate service data flow filters based on the IP tuples (e.g., IP 5-tuples) provided by the P-CSCF 107. The created PCC rule may be sent to the PCF 106, and may trigger a session modification procedure to establish the QoS flow for the transport of data channel traffic. In some examples (e.g., the data channel application data ID is included in the media description of the SDP), the PCF 106 may verify the QoS hint provided by the UE 115-a may determine a proposed QoS configuration based on network operator policy.

At 345, the UE 115-b may receive an SDP response for the application associated with the data channel in response to the SDP request transmitted at 305. The P-CSCF 107 may forward the offer SDP response to the UE 115-b. The SDP response may authorize a QoS resource on the data channel that satisfies the threshold QoS. The UE 115-a may then transmit a response confirmation based on having received the SDP response. The UE 115-b may initiate communication by the application (e.g., with the UE 115-c, or with another wireless device, or network entity 105, among other examples) in an IMS session, such as an SDP session (e.g., according to the threshold QoS). The P-CSCF 107 may forward the SDP response to the UE 115-b, and the UE 115-b may confirm receipt of the SDP response and send a response confirmation to the P-CSCF 107.

As described herein, the DChS may generate a CDR triggered by one or more events. Such events may include a bootstrap data channel establishment, update, and/or release, downloading or installing of a data channel application, UE application triggered data channel establishment via DChS, etc. IMS network entities (e.g., S-CSCF 106, P-CSCF 107, an IMS-AS, an MRFC, an IBCF, or the like) may support generation of CDRs in SDP negotiations, including data channel application IDs for each data channel stream. A PCF 106 may support functionality including deriving QoS parameters based on receiving QoS hint attributes from the P-CSCF 107, and verifying data channel QoS requirements via data channel application IDs.

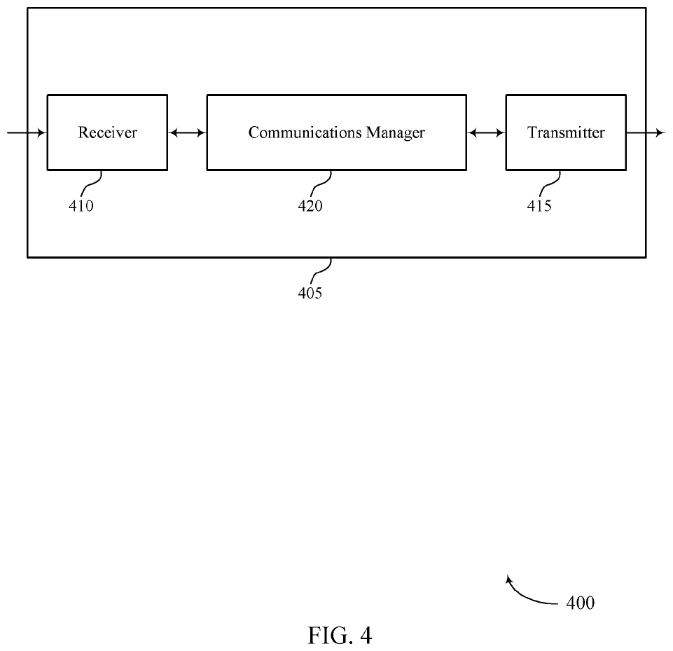

FIG. 4 shows a block diagram 400 of a device 405 that supports policy control and charging for data channels in internet protocol multimedia subsystem networks in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to policy control and charging for data channels in internet protocol multimedia subsystem networks). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to policy control and charging for data channels in internet protocol multimedia subsystem networks). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of policy control and charging for data channels in internet protocol multimedia subsystem networks as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for transmitting an SDP offer for an application associated with a data channel, the SDP offer including an application identifier associated with the application and one or more indications of a threshold quality of service associated with the application. The communications manager 420 may be configured as or otherwise support a means for receiving an SDP response for the application associated with the data channel based on transmitting the SDP offer, the SDP offer authorizing a quality of service resource that satisfies the threshold quality of service. The communications manager 420 may be configured as or otherwise support a means for transmitting a response confirmation based on receiving the SDP response.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for IMS sessions resulting in more reliable service, improved communication quality, more accurate and helpful charging information, and improved user experience.

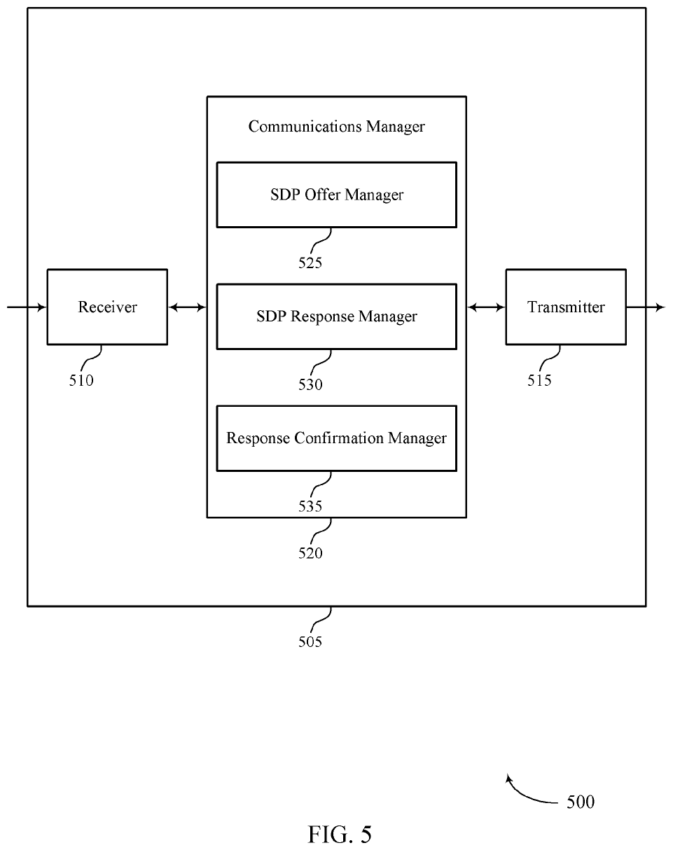

FIG. 5 shows a block diagram 500 of a device 505 that supports policy control and charging for data channels in internet protocol multimedia subsystem networks in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to policy control and charging for data channels in internet protocol multimedia subsystem networks). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to policy control and charging for data channels in internet protocol multimedia subsystem networks). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of policy control and charging for data channels in internet protocol multimedia subsystem networks as described herein. For example, the communications manager 520 may include an SDP offer manager 525, an SDP response manager 530, a response confirmation manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The SDP offer manager 525 may be configured as or otherwise support a means for transmitting an SDP offer for an application associated with a data channel, the SDP offer including an application identifier associated with the application and one or more indications of a threshold quality of service associated with the application. The SDP response manager 530 may be configured as or otherwise support a means for receiving an SDP response for the application associated with the data channel based on transmitting the SDP offer, the SDP offer authorizing a quality of service resource that satisfies the threshold quality of service. The response confirmation manager 535 may be configured as or otherwise support a means for transmitting a response confirmation based on receiving the SDP response.

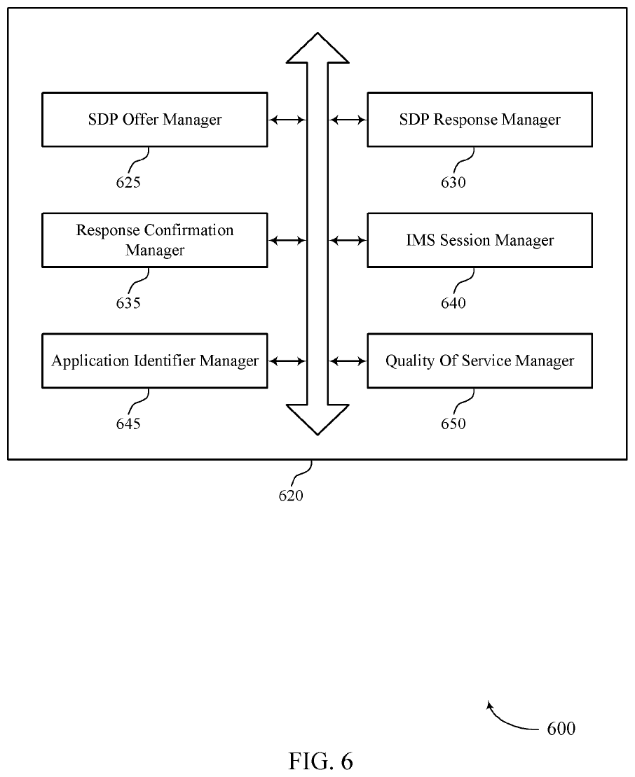

FIG. 6 shows a block diagram 600 of a communications manager 620 that supports policy control and charging for data channels in internet protocol multimedia subsystem networks in accordance with one or more aspects of the present disclosure. The communications manager 620 may be an example of aspects of a communications manager 420, a communications manager 520, or both, as described herein. The communications manager 620, or various components thereof, may be an example of means for performing various aspects of policy control and charging for data channels in internet protocol multimedia subsystem networks as described herein. For example, the communications manager 620 may include an SDP offer manager 625, an SDP response manager 630, a response confirmation manager 635, an IMS session manager 640, an application identifier manager 645, a quality of service manager 650, or any combination thereof. Each of these components may communicate, directly or indirectly, with one another (e.g., via one or more buses).

The communications manager 620 may support wireless communications at a UE in accordance with examples as disclosed herein. The SDP offer manager 625 may be configured as or otherwise support a means for transmitting an SDP offer for an application associated with a data channel, the SDP offer including an application identifier associated with the application and one or more indications of a threshold quality of service associated with the application. The SDP response manager 630 may be configured as or otherwise support a means for receiving an SDP response for the application associated with the data channel based on transmitting the SDP offer, the SDP offer authorizing a quality of service resource that satisfies the threshold quality of service. The response confirmation manager 635 may be configured as or otherwise support a means for transmitting a response confirmation based on receiving the SDP response.

In some examples, the IMS session manager 640 may be configured as or otherwise support a means for initiating communication by the application on the data channel in an internet protocol multimedia subsystem session based on outputting the SDP response and according to the threshold quality of service.

In some examples, the application identifier includes a label indicating a name of the data channel.

In some examples, the application identifier includes a media level attribute of a data channel map associated with the data channel.

In some examples, the application identifier includes a media level attribute of a data channel sub-protocol attribute associated with the data channel.

In some examples, the application identifier manager 645 may be configured as or otherwise support a means for a public land mobile network identifier, a data channel application provider, a data channel application number allocated by a network provider, a data channel application name, or any combination thereof.

In some examples, to a support threshold quality of service, the quality of service manager 650 may be configured as or otherwise support a means for a threshold packet loss for the application, a threshold latency for the application, or both.

In some examples, the application identifier manager 645 may be configured as or otherwise support a means for obtaining an indication of the application identifier in connection with installing the application at the UE. In some examples, the application identifier manager 645 may be configured as or otherwise support a means for including the application identifier in the SDP offer.

In some examples, the application identifier manager 645 may be configured as or otherwise support a means for receiving a data channel application package associated with the application, the data channel application package including the application identifier. In some examples, the application identifier manager 645 may be configured as or otherwise support a means for including the application identifier in the SDP offer based on the data channel application package.

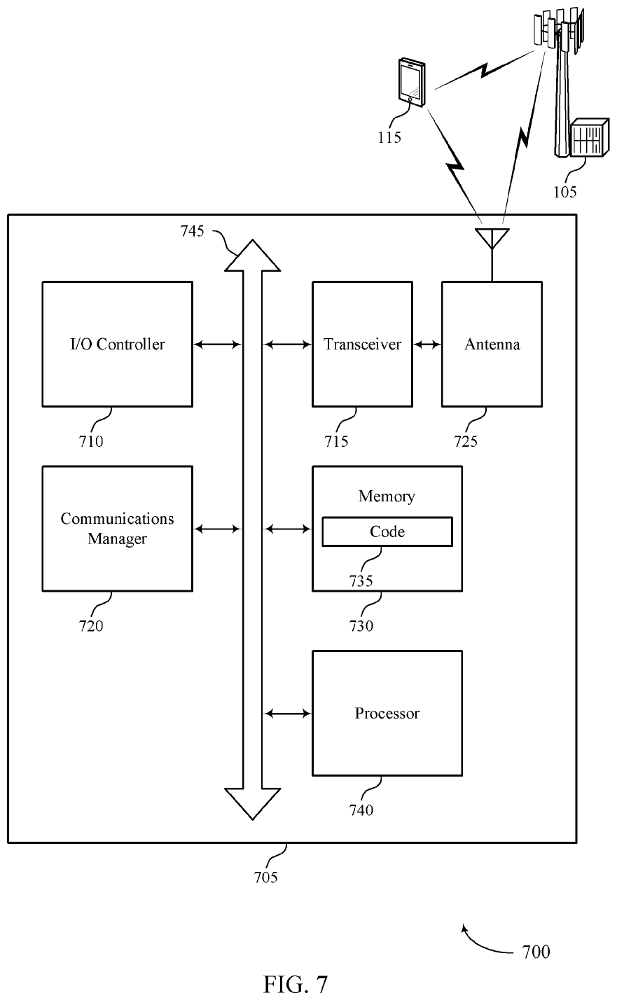

FIG. 7 shows a diagram of a system 700 including a device 705 that supports policy control and charging for data channels in internet protocol multimedia subsystem networks in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting policy control and charging for data channels in internet protocol multimedia subsystem networks). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for transmitting an SDP offer for an application associated with a data channel, the SDP offer including an application identifier associated with the application and one or more indications of a threshold quality of service associated with the application. The communications manager 720 may be configured as or otherwise support a means for receiving an SDP response for the application associated with the data channel based on transmitting the SDP offer, the SDP offer authorizing a quality of service resource that satisfies the threshold quality of service. The communications manager 720 may be configured as or otherwise support a means for transmitting a response confirmation based on receiving the SDP response.

By including or configuring the communications manager 720 in accordance with examples as described herein, the device 705 may support techniques for IMS sessions resulting in more reliable service, improved communication quality, more accurate and helpful charging information, and improved user experience.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of policy control and charging for data channels in internet protocol multimedia subsystem networks as described herein, or the processor 740 and the memory 730 may be otherwise configured to perform or support such operations.

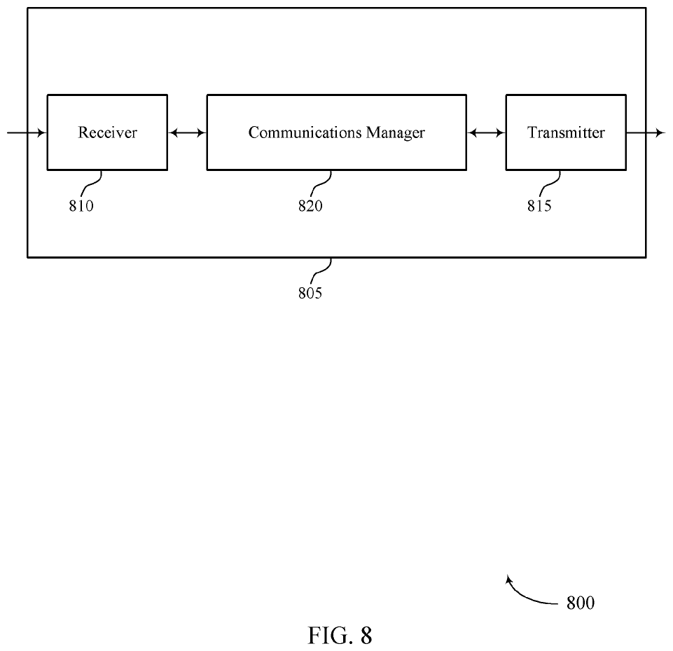

FIG. 8 shows a block diagram 800 of a device 805 that supports policy control and charging for data channels in internet protocol multimedia subsystem networks in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of policy control and charging for data channels in internet protocol multimedia subsystem networks as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network device in accordance with examples as disclosed herein. For example, the communications manager 820 may be configured as or otherwise support a means for obtaining an SDP offer from a first UE for an application associated with a data channel, the SDP offer including an application identifier associated with the application and one or more indications of a threshold quality of service associated with the application. The communications manager 820 may be configured as or otherwise support a means for outputting an SDP response for the application associated with the data channel based on receiving the SDP offer, the SDP offer authorizing a quality of service resource that satisfies the threshold quality of service. The communications manager 820 may be configured as or otherwise support a means for obtaining a response confirmation based on receiving the SDP response.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for IMS sessions resulting in more reliable service, improved communication quality, more accurate and helpful charging information, and improved user experience.

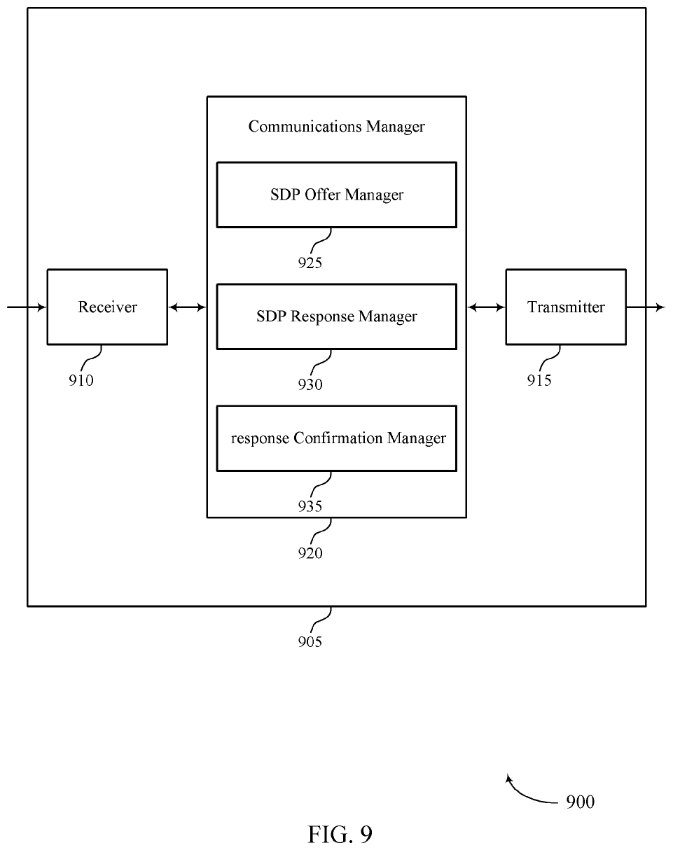

FIG. 9 shows a block diagram 900 of a device 905 that supports policy control and charting charging for data channels in internet protocol multimedia subsystem networks in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of policy control and charging for data channels in internet protocol multimedia subsystem networks as described herein. For example, the communications manager 920 may include an SDP offer manager 925, an SDP response manager 930, a response confirmation manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network device in accordance with examples as disclosed herein. The SDP offer manager 925 may be configured as or otherwise support a means for obtaining an SDP offer from a first UE for an application associated with a data channel, the SDP offer including an application identifier associated with the application and one or more indications of a threshold quality of service associated with the application. The SDP response manager 930 may be configured as or otherwise support a means for outputting an SDP response for the application associated with the data channel based on receiving the SDP offer, the SDP offer authorizing a quality of service resource that satisfies the threshold quality of service. The response confirmation manager 935 may be configured as or otherwise support a means for obtaining a response confirmation based on receiving the SDP response.

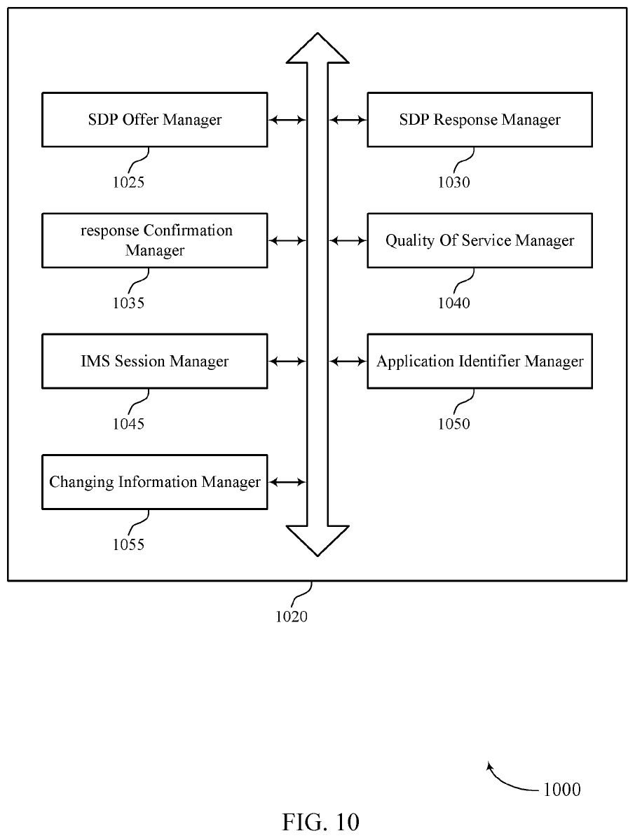

FIG. 10 shows a block diagram 1000 of a communications manager 1020 that supports policy control and charging for data channels in internet protocol multimedia subsystem networks in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of policy control and charging for data channels in internet protocol multimedia subsystem networks as described herein. For example, the communications manager 1020 may include an SDP offer manager 1025, an SDP response manager 1030, a response confirmation manager 1035, a quality of service manager 1040, an IMS session manager 1045, an application identifier manager 1050, a changing information manager 1055, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network device in accordance with examples as disclosed herein. The SDP offer manager 1025 may be configured as or otherwise support a means for obtaining an SDP offer from a first UE for an application associated with a data channel, the SDP offer including an application identifier associated with the application and one or more indications of a threshold quality of service associated with the application. The SDP response manager 1030 may be configured as or otherwise support a means for outputting an SDP response for the application associated with the data channel based on receiving the SDP offer, the SDP offer authorizing a quality of service resource that satisfies the threshold quality of service. The response confirmation manager 1035 may be configured as or otherwise support a means for obtaining a response confirmation based on receiving the SDP response.

In some examples, the quality of service manager 1040 may be configured as or otherwise support a means for authorizing a quality of service resource that satisfies the threshold quality of service, where outputting the SDP response is based on the authorizing.

In some examples, the SDP offer manager 1025 may be configured as or otherwise support a means for forwarding the SDP offer to a second UE. In some examples, the SDP response manager 1030 may be configured as or otherwise support a means for obtaining the SDP response from the second UE.

In some examples, to support outputting the SDP response, the SDP response manager 1030 may be configured as or otherwise support a means for forwarding the SDP response obtained from the second UE to the first UE.

In some examples, the IMS session manager 1045 may be configured as or otherwise support a means for initiating communication by the application on the data channel in an internet protocol multimedia subsystem session based on outputting the SDP response and according to the threshold quality of service.

In some examples, the changing information manager 1055 may be configured as or otherwise support a means for generating charging information associated with the application for the internet protocol multimedia subsystem session based on the application identifier.

In some examples, the changing information manager 1055 may be configured as or otherwise support a means for providing the charging information to a service provider associated with the first UE.

In some examples, the application identifier includes a label indicating a name of the data channel.

In some examples, the application identifier includes a media level attribute of a data channel map associated with the data channel.

In some examples, the application identifier includes a media level attribute of a data channel sub-protocol attribute associated with the data channel.

In some examples, the application identifier manager 1050 may be configured as or otherwise support a means for a public land mobile network identifier, a data channel application number allocated by a network provider, a data channel application name, or any combination thereof.

In some examples, the application identifier manager 1050 may be configured as or otherwise support a means for associating the application identifier with a data channel application package corresponding to the application, where receiving the SDP offer including the application identifier is based on associating the application identifier with the data channel application package.

In some examples, to support threshold quality of service, the quality of service manager 1040 may be configured as or otherwise support a means for a threshold packet loss for the application, a threshold latency for the application, or both.

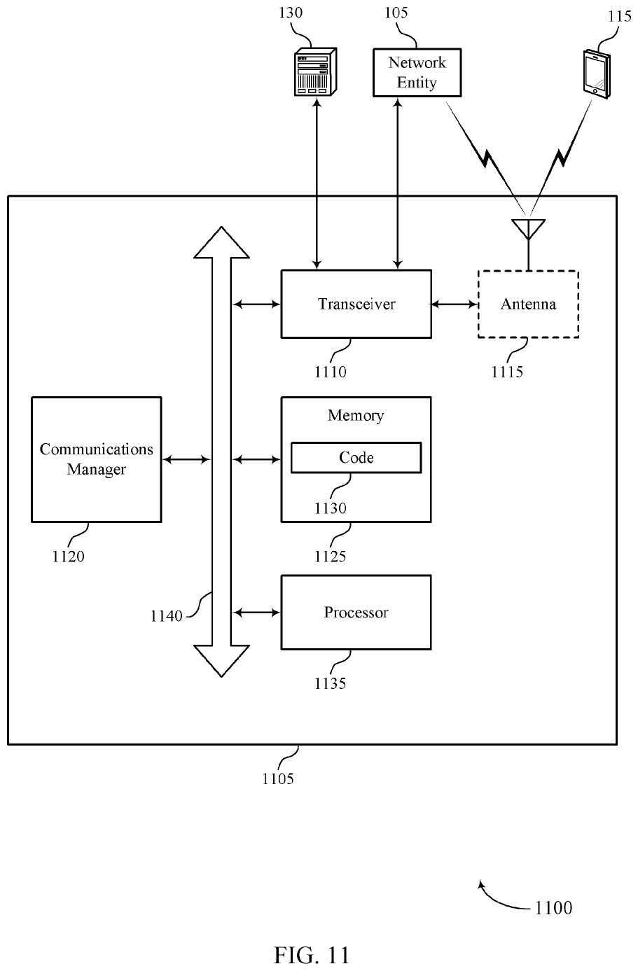

FIG. 11 shows a diagram of a system 1100 including a device 1105 that supports policy control and charging for data channels in internet protocol multimedia subsystem networks in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting policy control and charging for data channels in internet protocol multimedia subsystem networks). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network device in accordance with examples as disclosed herein. For example, the communications manager 1120 may be configured as or otherwise support a means for obtaining an SDP offer from a first UE for an application associated with a data channel, the SDP offer including an application identifier associated with the application and one or more indications of a threshold quality of service associated with the application. The communications manager 1120 may be configured as or otherwise support a means for outputting an SDP response for the application associated with the data channel based on receiving the SDP offer, the SDP offer authorizing a quality of service resource that satisfies the threshold quality of service. The communications manager 1120 may be configured as or otherwise support a means for obtaining a response confirmation based on receiving the SDP response.

By including or configuring the communications manager 1120 in accordance with examples as described herein, the device 1105 may support techniques for IMS sessions resulting in more reliable service, improved communication quality, more accurate and helpful charging information, and improved user experience.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of policy control and charging for data channels in internet protocol multimedia subsystem networks as described herein, or the processor 1135 and the memory 1125 may be otherwise configured to perform or support such operations.

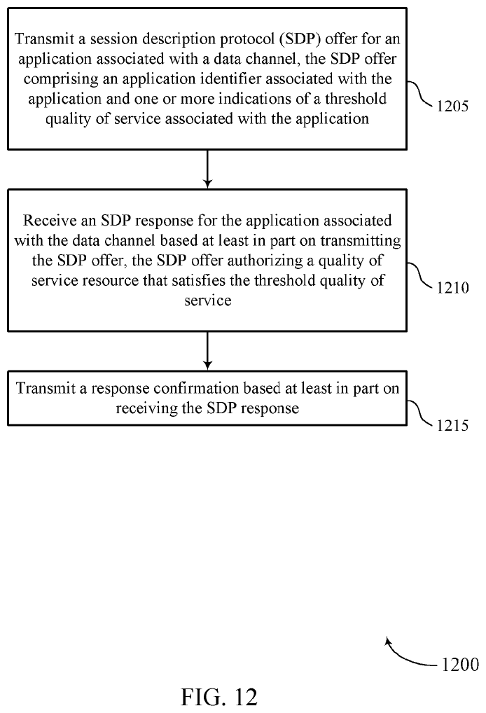

FIG. 12 shows a flowchart illustrating a method 1200 that supports policy control and charging for data channels in internet protocol multimedia subsystem networks in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting an SDP offer for an application associated with a data channel, the SDP offer including an application identifier associated with the application and one or more indications of a threshold quality of service associated with the application. The operations of 1205 may be performed in accordance with examples as disclosed herein. In some examples, aspects of the operations of 1205 may be performed by an SDP offer manager 625 as described with reference to FIG. 6.

At 1210, the method may include receiving an SDP response for the application associated with the data channel based on transmitting the SDP offer, the SDP offer authorizing a quality of service resource that satisfies the threshold quality of service. The operations of 1210 may be performed in accordance with examples as disclosed herein. In some examples, aspects of the operations of 1210 may be performed by an SDP response manager 630 as described with reference to FIG. 6.

At 1215, the method may include transmitting a response confirmation based on receiving the SDP response. The operations of 1215 may be performed in accordance with examples as disclosed herein. In some examples, aspects of the operations of 1215 may be performed by a response confirmation manager 635 as described with reference to FIG. 6.

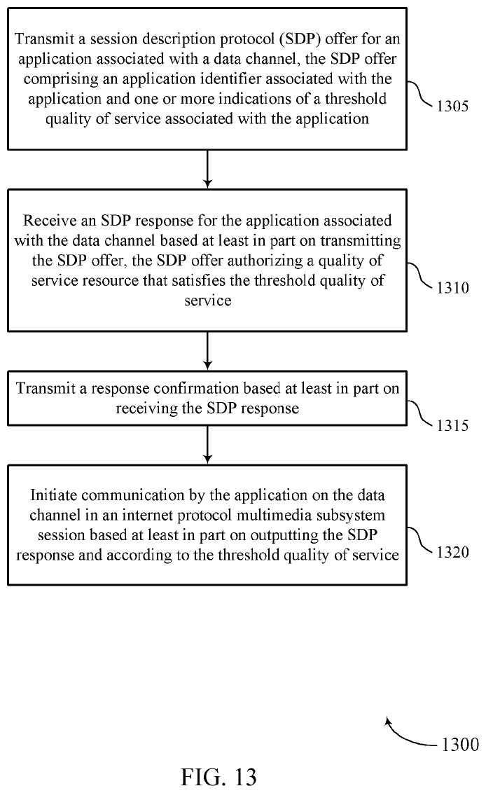

FIG. 13 shows a flowchart illustrating a method 1300 that supports policy control and charging for data channels in internet protocol multimedia subsystem networks in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include transmitting an SDP offer for an application associated with a data channel, the SDP offer including an application identifier associated with the application and one or more indications of a threshold quality of service associated with the application. The operations of 1305 may be performed in accordance with examples as disclosed herein. In some examples, aspects of the operations of 1305 may be performed by an SDP offer manager 625 as described with reference to FIG. 6.

At 1310, the method may include receiving an SDP response for the application associated with the data channel based on transmitting the SDP offer, the SDP offer authorizing a quality of service resource that satisfies the threshold quality of service. The operations of 1310 may be performed in accordance with examples as disclosed herein. In some examples, aspects of the operations of 1310 may be performed by an SDP response manager 630 as described with reference to FIG. 6.

At 1315, the method may include transmitting a response confirmation based on receiving the SDP response. The operations of 1315 may be performed in accordance with examples as disclosed herein. In some examples, aspects of the operations of 1315 may be performed by a response confirmation manager 635 as described with reference to FIG. 6.

At 1320, the method may include initiating communication by the application on the data channel in an internet protocol multimedia subsystem session based on outputting the SDP response and according to the threshold quality of service. The operations of 1320 may be performed in accordance with examples as disclosed herein. In some examples, aspects of the operations of 1320 may be performed by an IMS session manager 640 as described with reference to FIG. 6.

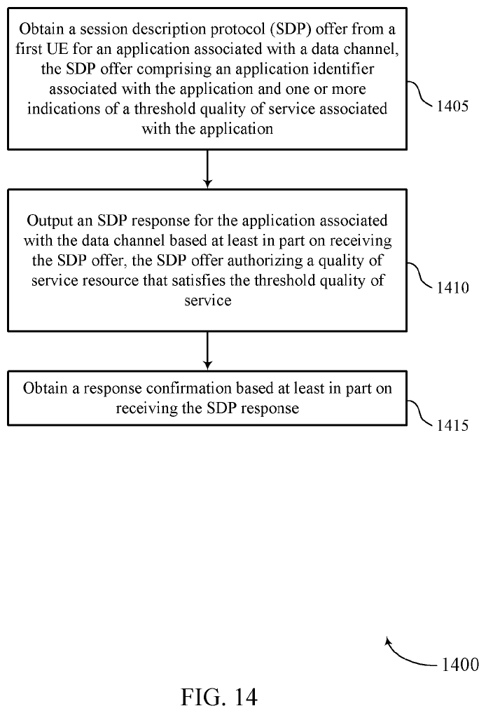

FIG. 14 shows a flowchart illustrating a method 1400 that supports policy control and charging for data channels in internet protocol multimedia subsystem networks in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include obtaining an SDP offer from a first UE for an application associated with a data channel, the SDP offer including an application identifier associated with the application and one or more indications of a threshold quality of service associated with the application. The operations of 1405 may be performed in accordance with examples as disclosed herein. In some examples, aspects of the operations of 1405 may be performed by an SDP offer manager 1025 as described with reference to FIG. 10.

At 1410, the method may include outputting an SDP response for the application associated with the data channel based on receiving the SDP offer, the SDP offer authorizing a quality of service resource that satisfies the threshold quality of service. The operations of 1410 may be performed in accordance with examples as disclosed herein. In some examples, aspects of the operations of 1410 may be performed by an SDP response manager 1030 as described with reference to FIG. 10.

At 1415, the method may include obtaining a response confirmation based on receiving the SDP response. The operations of 1415 may be performed in accordance with examples as disclosed herein. In some examples, aspects of the operations of 1415 may be performed by a response confirmation manager 1035 as described with reference to FIG. 10.

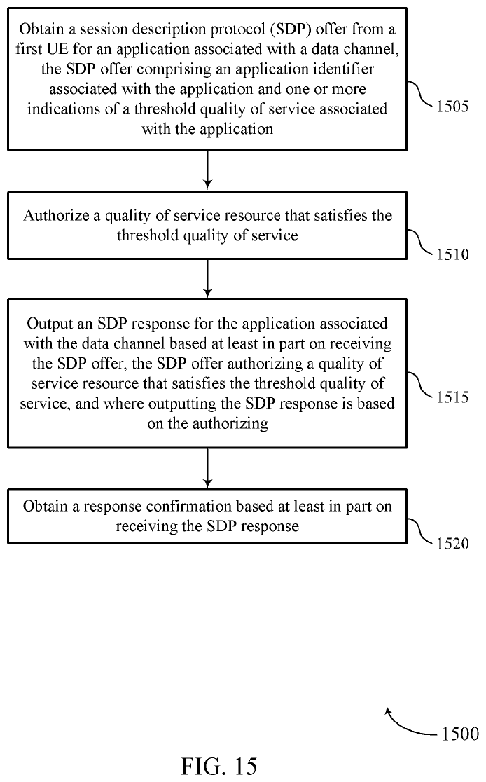

FIG. 15 shows a flowchart illustrating a method 1500 that supports policy control and charging for data channels in internet protocol multimedia subsystem networks in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include obtaining an SDP offer from a first UE for an application associated with a data channel, the SDP offer including an application identifier associated with the application and one or more indications of a threshold quality of service associated with the application. The operations of 1505 may be performed in accordance with examples as disclosed herein. In some examples, aspects of the operations of 1505 may be performed by an SDP offer manager 1025 as described with reference to FIG. 10.

At 1510, the method may include authorizing a quality of service resource that satisfies the threshold quality of service. The operations of 1510 may be performed in accordance with examples as disclosed herein. In some examples, aspects of the operations of 1510 may be performed by a quality of service manager 1040 as described with reference to FIG. 10.

At 1515, the method may include outputting an SDP response for the application associated with the data channel based on receiving the SDP offer, the SDP offer authorizing a quality of service resource that satisfies the threshold quality of service, and where outputting the SDP response is based on the authorizing. The operations of 1515 may be performed in accordance with examples as disclosed herein. In some examples, aspects of the operations of 1515 may be performed by an SDP response manager 1030 as described with reference to FIG. 10.

At 1520, the method may include obtaining a response confirmation based on receiving the SDP response. The operations of 1520 may be performed in accordance with examples as disclosed herein. In some examples, aspects of the operations of 1520 may be performed by a response confirmation manager 1035 as described with reference to FIG. 10.

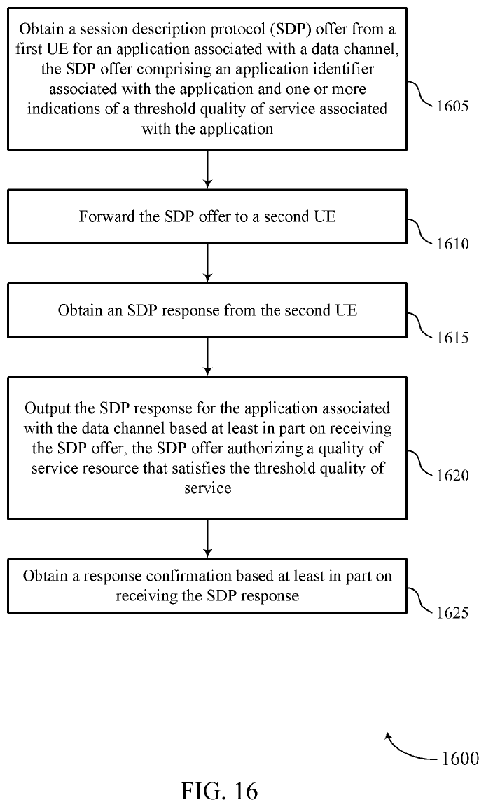

FIG. 16 shows a flowchart illustrating a method 1600 that supports policy control and charging for data channels in internet protocol multimedia subsystem networks in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include obtaining an SDP offer from a first UE for an application associated with a data channel, the SDP offer including an application identifier associated with the application and one or more indications of a threshold quality of service associated with the application. The operations of 1605 may be performed in accordance with examples as disclosed herein. In some examples, aspects of the operations of 1605 may be performed by an SDP offer manager 1025 as described with reference to FIG. 10.

At 1610, the method may include forwarding the SDP offer to a second UE. The operations of 1610 may be performed in accordance with examples as disclosed herein. In some examples, aspects of the operations of 1610 may be performed by an SDP offer manager 1025 as described with reference to FIG. 10.

At 1615, the method may include obtaining an SDP response from the second UE. The operations of 1615 may be performed in accordance with examples as disclosed herein. In some examples, aspects of the operations of 1615 may be performed by an SDP response manager 1030 as described with reference to FIG. 10.

At 1620, the method may include outputting the SDP response for the application associated with the data channel based on receiving the SDP offer, the SDP offer authorizing a quality of service resource that satisfies the threshold quality of service. The operations of 1620 may be performed in accordance with examples as disclosed herein. In some examples, aspects of the operations of 1620 may be performed by an SDP response manager 1030 as described with reference to FIG. 10.

At 1625, the method may include obtaining a response confirmation based on receiving the SDP response. The operations of 1625 may be performed in accordance with examples as disclosed herein. In some examples, aspects of the operations of 1625 may be performed by a response confirmation manager 1035 as described with reference to FIG. 10.

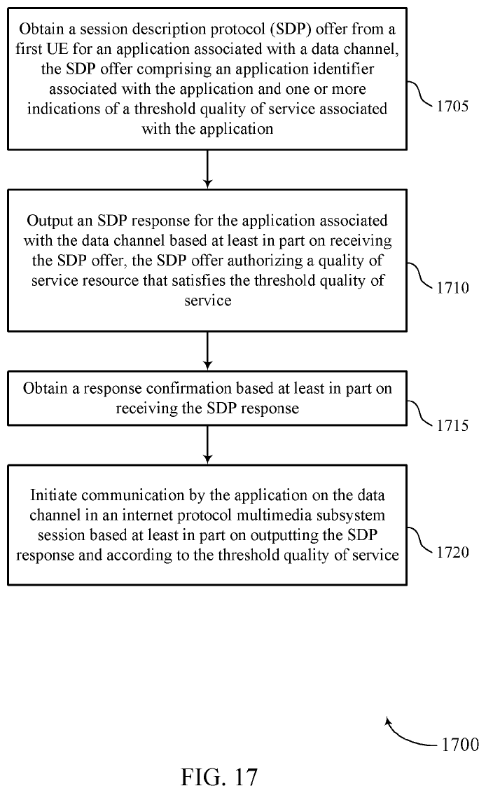

FIG. 17 shows a flowchart illustrating a method 1700 that supports policy control and charging for data channels in internet protocol multimedia subsystem networks in accordance with one or more aspects of the present disclosure. The operations of the method 1700 may be implemented by a network entity or its components as described herein. For example, the operations of the method 1700 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1705, the method may include obtaining an SDP offer from a first UE for an application associated with a data channel, the SDP offer including an application identifier associated with the application and one or more indications of a threshold quality of service associated with the application. The operations of 1705 may be performed in accordance with examples as disclosed herein. In some examples, aspects of the operations of 1705 may be performed by an SDP offer manager 1025 as described with reference to FIG. 10.

At 1710, the method may include outputting an SDP response for the application associated with the data channel based on receiving the SDP offer, the SDP offer authorizing a quality of service resource that satisfies the threshold quality of service. The operations of 1710 may be performed in accordance with examples as disclosed herein. In some examples, aspects of the operations of 1710 may be performed by an SDP response manager 1030 as described with reference to FIG. 10.

At 1715, the method may include obtaining a response confirmation based on receiving the SDP response. The operations of 1715 may be performed in accordance with examples as disclosed herein. In some examples, aspects of the operations of 1715 may be performed by a response confirmation manager 1035 as described with reference to FIG. 10.

At 1720, the method may include initiating communication by the application on the data channel in an internet protocol multimedia subsystem session based on outputting the SDP response and according to the threshold quality of service. The operations of 1720 may be performed in accordance with examples as disclosed herein. In some examples, aspects of the operations of 1720 may be performed by an IMS session manager 1045 as described with reference to FIG. 10.

The following provides an overview of aspects of the present disclosure:

Aspect 1: A method for wireless communications at a UE, comprising: transmitting an SDP offer for an application associated with a data channel, the SDP offer comprising an application identifier associated with the application and one or more indications of a threshold quality of service associated with the application; receiving an SDP response for the application associated with the data channel based at least in part on transmitting the SDP offer, the SDP offer authorizing a quality of service resource that satisfies the threshold quality of service; and transmitting a response confirmation based at least in part on receiving the SDP response.

Aspect 2: The method of aspect 1, further comprising: initiating communication by the application on the data channel in an internet protocol multimedia subsystem session based at least in part on outputting the SDP response and according to the threshold quality of service.

Aspect 3: The method of any of aspects 1 through 2, wherein the application identifier comprises a label indicating a name of the data channel.

Aspect 4: The method of any of aspects 1 through 3, wherein the application identifier comprises a media level attribute of a data channel map associated with the data channel.

Aspect 5: The method of any of aspects 1 through 4, wherein the application identifier comprises a media level attribute of a data channel sub-protocol attribute associated with the data channel.

Aspect 6: The method of any of aspects 1 through 5, wherein the application identifier comprises one or more parameter values, the one or more parameter values comprising: a public land mobile network identifier, a data channel application provider, a data channel application number allocated by a network provider, a data channel application name, or any combination thereof.

Aspect 7: The method of any of aspects 1 through 6, wherein the threshold quality of service comprises: a threshold packet loss for the application, a threshold latency for the application, or both.

Aspect 8: The method of any of aspects 1 through 7, further comprising: obtaining an indication of the application identifier in connection with installing the application at the UE; and including the indication of the application identifier in the SDP offer.

Aspect 9: The method of any of aspects 1 through 8, further comprising: receiving a data channel application package associated with the application, the data channel application package comprising the application identifier; and including the indication of the application identifier in the SDP offer based at least in part on the data channel application package.

Aspect 10: A method for wireless communications at a network device, comprising: obtaining an SDP offer from a first UE for an application associated with a data channel, the SDP offer comprising an application identifier associated with the application and one or more indications of a threshold quality of service associated with the application; outputting an SDP response for the application associated with the data channel based at least in part on obtaining the SDP offer, the SDP offer authorizing a quality of service resource that satisfies the threshold quality of service; and obtaining a response confirmation based at least in part on outputting the SDP response.

Aspect 11: The method of aspect 10, further comprising: authorizing a quality of service resource that satisfies the threshold quality of service, wherein outputting the SDP response is based at least in part on the authorizing.

Aspect 12: The method of any of aspects 10 through 11, further comprising: forwarding the SDP offer to a second UE; and obtaining the SDP response from the second UE.

Aspect 13: The method of aspect 12, wherein outputting the SDP response comprises: forwarding the SDP response obtained from the second UE to the first UE.

Aspect 14: The method of any of aspects 10 through 13, further comprising: initiating communication by the application on the data channel in an internet protocol multimedia subsystem session based at least in part on outputting the SDP response and according to the threshold quality of service.

Aspect 15: The method of aspect 14, further comprising: generating charging information associated with the application for the internet protocol multimedia subsystem session based at least in part on the application identifier.

Aspect 16: The method of aspect 15, further comprising: providing the charging information to a service provider associated with the first UE.

Aspect 17: The method of any of aspects 10 through 16, wherein the application identifier comprises a label indicating a name of the data channel.

Aspect 18: The method of any of aspects 10 through 17, wherein the application identifier comprises a media level attribute of a data channel map associated with the data channel.

Aspect 19: The method of any of aspects 10 through 18, wherein the application identifier comprises a media level attribute of a data channel sub-protocol attribute associated with the data channel.

Aspect 20: The method of any of aspects 10 through 19, wherein the application identifier comprises one or more parameter values, the one or more parameter values comprising: a public land mobile network identifier, a data channel application number allocated by a network provider, a data channel application name, or any combination thereof.

Aspect 21: The method of any of aspects 10 through 20, further comprising: associating the application identifier with a data channel application package corresponding to the application, wherein receiving the SDP offer comprising the application identifier is based at least in part on associating the application identifier with the data channel application package.

Aspect 22: The method of any of aspects 10 through 21, wherein the threshold quality of service comprises: a threshold packet loss for the application, a threshold latency for the application, or both.

Aspect 23: An apparatus for wireless communications at a UE, comprising a processor; memory coupled with the processor; and instructions stored in the memory and executable by the processor to cause the apparatus to perform a method of any of aspects 1 through 9.

Aspect 24: An apparatus for wireless communications at a UE, comprising at least one means for performing a method of any of aspects 1 through 9.

Aspect 25: A non-transitory computer-readable medium storing code for wireless communications at a UE, the code comprising instructions executable by a processor to perform a method of any of aspects 1 through 9.

Aspect 26: An apparatus for wireless communications at a network device, comprising a processor; memory coupled with the processor; and instructions stored in the memory and executable by the processor to cause the apparatus to perform a method of any of aspects 10 through 22.

Aspect 27: An apparatus for wireless communications at a network device, comprising at least one means for performing a method of any of aspects 10 through 22.

Aspect 28: A non-transitory computer-readable medium storing code for wireless communications at a network device, the code comprising instructions executable by a processor to perform a method of any of aspects 10 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
transmit a session description protocol (SDP) offer for an application associated with a data channel, the SDP offer comprising an application identifier associated with the application and one or more indications of a threshold quality of service associated with the application;
receive an SDP response for the application associated with the data channel based at least in part on transmitting the SDP offer, the SDP offer authorizing a quality of service resource that satisfies the threshold quality of service; and
transmit a response confirmation based at least in part on receiving the SDP response.

2. The apparatus of claim 1, wherein the instructions are further executable by the processor to cause the apparatus to:
initiate communication by the application on the data channel in an internet protocol multimedia subsystem session based at least in part on outputting the SDP response and according to the threshold quality of service.

3. The apparatus of claim 1, wherein the application identifier comprises a label indicating a name of the data channel.

4. The apparatus of claim 1, wherein the application identifier comprises a media level attribute of a data channel map associated with the data channel.

5. The apparatus of claim 1, wherein the application identifier comprises a media level attribute of a data channel sub-protocol attribute associated with the data channel.

6. The apparatus of claim 1, wherein the instructions to are executable by the processor to cause the apparatus to:
a public land mobile network identifier, a data channel application provider, a data channel application number allocate by a network provider, a data channel application name, or any combination thereof.

7. The apparatus of claim 1, wherein the instructions to threshold quality of service are executable by the processor to cause the apparatus to:
a threshold packet loss for the application, a threshold latency for the application, or both.

8. The apparatus of claim 1, wherein the instructions are further executable by the processor to cause the apparatus to:
obtain an indication of the application identifier in connection with installing the application at the UE; and
include the application identifier in the SDP offer.

9. The apparatus of claim 1, wherein the instructions are further executable by the processor to cause the apparatus to:
receive a data channel application package associated with the application, the data channel application package comprising the application identifier; and
include the application identifier in the SDP offer based at least in part on the data channel application package.

10. An apparatus for wireless communications at a network device, comprising:
a processor;
memory coupled with the processor; and
instructions stored in the memory and executable by the processor to cause the apparatus to:
obtain a session description protocol (SDP) offer from a first user equipment (UE) for an application associated with a data channel, the SDP offer comprising an application identifier associated with the application and one or more indications of a threshold quality of service associated with the application;
output an SDP response for the application associated with the data channel based at least in part on obtaining the SDP offer, the SDP offer authorizing a quality of service resource that satisfies the threshold quality of service; and
obtain a response confirmation based at least in part on outputting the SDP response.

11. The apparatus of claim 10, wherein the instructions are further executable by the processor to cause the apparatus to:
authorize a quality of service resource that satisfies the threshold quality of service, wherein outputting the SDP response is based at least in part on the authorizing.

12. The apparatus of claim 10, wherein the instructions are further executable by the processor to cause the apparatus to:
forward the SDP offer to a second UE; and
obtain the SDP response from the second UE.

13. The apparatus of claim 12, wherein the instructions to output the SDP response are executable by the processor to cause the apparatus to:
forward the SDP response obtained from the second UE to the first UE.

14. The apparatus of claim 10, wherein the instructions are further executable by the processor to cause the apparatus to:
initiate communication by the application on the data channel in an internet protocol multimedia subsystem session based at least in part on outputting the SDP response and according to the threshold quality of service.

15. The apparatus of claim 14, wherein the instructions are further executable by the processor to cause the apparatus to:
generate charging information associated with the application for the internet protocol multimedia subsystem session based at least in part on the application identifier.

16. The apparatus of claim 15, wherein the instructions are further executable by the processor to cause the apparatus to:
provide the charging information to a service provider associated with the first UE.

17. The apparatus of claim 10, wherein the application identifier comprises a label indicating a name of the data channel.

18. The apparatus of claim 10, wherein the application identifier comprises a media level attribute of a data channel map associated with the data channel.

19. The apparatus of claim 10, wherein the application identifier comprises a media level attribute of a data channel sub-protocol attribute associated with the data channel.

20. The apparatus of claim 10, wherein the instructions to are executable by the processor to cause the apparatus to:
a public land mobile network identifier, a data channel application number allocate by a network provider, a data channel application name, or any combination thereof.

21. The apparatus of claim 10, wherein the instructions are further executable by the processor to cause the apparatus to:
associate the application identifier with a data channel application package corresponding to the application, wherein receiving the SDP offer comprising the application identifier is based at least in part on associating the application identifier with the data channel application package.

22. The apparatus of claim 10, wherein the instructions to threshold quality of service are executable by the processor to cause the apparatus to:
a threshold packet loss for the application, a threshold latency for the application, or both.

23. A method for wireless communications at a user equipment (UE), comprising:
transmitting a session description protocol (SDP) offer for an application associated with a data channel, the SDP offer comprising an application identifier associated with the application and one or more indications of a threshold quality of service associated with the application;
receiving an SDP response for the application associated with the data channel based at least in part on transmitting the SDP offer, the SDP offer authorizing a quality of service resource that satisfies the threshold quality of service; and
transmitting a response confirmation based at least in part on receiving the SDP response.

24. The method of claim 23, wherein the application identifier comprises a label indicating a name of the data channel, a media level attribute of a data channel map associated with the data channel, or a data channel sub-protocol attribute associated with the data channel.

25. The method of claim 23, wherein the threshold quality of service comprises:
a threshold packet loss for the application, a threshold latency for the application, or both.

26. A method for wireless communications at a network device, comprising:
obtaining a session description protocol (SDP) offer from a first user equipment (UE) for an application associated with a data channel, the SDP offer comprising an application identifier associated with the application and one or more indications of a threshold quality of service associated with the application;
outputting an SDP response for the application associated with the data channel based at least in part on obtaining the SDP offer, the SDP offer authorizing a quality of service resource that satisfies the threshold quality of service; and
obtaining a response confirmation based at least in part on outputting the SDP response.

27. The method of claim 26, further comprising:
authorizing a quality of service resource that satisfies the threshold quality of service, wherein outputting the SDP response is based at least in part on the authorizing.

28. The method of claim 26, further comprising:
initiating communication by the application on the data channel in an internet protocol multimedia subsystem session based at least in part on outputting the SDP response and according to the threshold quality of service.

29. The method of claim 28, further comprising:
generating charging information associated with the application for the internet protocol multimedia subsystem session based at least in part on the application identifier.

30. The method of claim 29, further comprising:
providing the charging information to a service provider associated with the first UE.
